(19) United States
(12) Patent Application Publication
(10) Pub. No.: US 2008/0131167 A1
(43) Pub. Date: Jun. 5, 2008

(54) Computer to conductive anodized and grained platesetting system and apparatus

(75) Inventors: Robert C. Ross, Mobile, AL (US); Kenneth O. Parker, Mobile, AL (US)

Correspondence Address: VENABLE LLP, P.O. BOX 34385, WASHINGTON, DC, 20043-9998, US

(73) Assignee: Xante Corporation, Mobile, AL (US)

(21) Appl. No.: 12/000,259

(22) Filed: Dec. 11, 2007

Related U.S. Application Data
(62) Division of application No. 10/841,435, filed on May 10, 2004.

(51) Int. Cl. G03G 15/20

(52) U.S. Cl. 399/166; 399/320

(57) ABSTRACT

A platesetting system and apparatus for providing computer-to-plate electrophotographic printing to a conductive plate. The apparatus may include an electrophotographic printer adapted to include an electrically isolated media path for receiving a conductive plate. A conductive plate may include anodized and grained aluminum (AL) that does not include a light sensitive emulsion layer in a finished product. The plate may be adapted to include rounded corners. The plate may be adapted to include a protective leading edge. The plate may be fused using the absorbed light of a radiant heat source.

### BACKGROUND OF THE INVENTION

Around 1798, in Prague, Alois Senefelder was experimenting with Soinhofen limestone to find a cheaper alternative to engraving images on copper. The experiments of Senefelder with etching in relief were a failure, but he did notice that he could print just as well without the relief. That discovery, along with the invention of photography in the mid-1800's, changed the course of printing history. The discovery rendered letterpress virtually obsolete, and made offset lithography the predominant print technology of the 20th century.

The word lithography literally means “writing on stone.” Senefelder discovered that if a design is drawn on a limestone surface using a greasy crayon, and then the surface is “etched” with a solution of gum arabic, water, and a few drops of nitric acid, the area that has been drawn on becomes permanently receptive to grease. The undrawn area desensitized by the gum solution is permanently resistant to grease. If the stone is later dampened and greasy ink is applied from a roller, the ink sticks to the design but not to the rest of the surface. Impressions can then be taken which are exact replicas of the original design.

Over the years, the same properties were discovered in more manageable zinc and aluminum plates. The offset process was later developed to overcome the limitations of these metal plates. The offset process involved taking an impression not directly from the plate but from an intermediate blanket.

Offset lithography uses the principles of planographic printing. It is called ‘offset’ because the image is printed first on a rubber blanket (offset) and the rubber blanket then prints onto paper. The offset process has several clear advantages. Metal plates are easily damaged, and offsetting the image onto rubber protects the metal plates from damage. The resilience of the rubber blanket enables impressions to be made on even quite rough papers, and other substrates such as tinplate. Furthermore, the design on the original stone had to be drawn as a mirror image of the finished design for it to print correctly. But because the image is first offset—printed to the blanket—and then onto the paper, the design for offset litho can be positive and “right reading.”

Lithography might have become more popular sooner if typesetting were not such a problem. It was possible to transfer typeset by letterpress onto the litho plate using paper with the ink still wet. But it was not until the invention of photography that type could be placed onto a litho plate with any kind of quality control.

Platemaking is the process by which a design is transferred onto a printing plate from artwork or mechanical, either photographically or electrostatically, by a process resembling photocopying. Offset litho plates have to be thin and flexible enough to wrap around a cylinder. Conventionally, small plates are supplied pre-sensitized with a light-sensitive emulsion, a diazo compound or photopolymer, and are made from metal, plastic, or paper. Paper and plastic (polyester) are used for short runs, such as, e.g., up to 15,000 copies. Because the paper or polyester plates stretch and distort on the press, these plates are only suitable for single or spot color work. The paper or polyester plates are exposed under a process camera, “developed” electrostatically, and then “fixed” by heat. Alternately, the plates are placed in direct contact with the artwork and the image is transferred using a photographic process similar to the production of photomechanical transfers (PMTs).

Metal plates are made from aluminum with a granular surface, which gives the plate water-carrying properties, and provides anchorage to the image. Litho plates for larger machines and some smaller conventional metal plates can be exposed from either negative or positive film

Exposure or burn is made by ultraviolet light in a printing-down frame which holds the metal plate in direct vacuum contact with the flat. On exposure, the diazo light sensitive emulsion or photopolymer resin coating of a negative-working plate radiated by the ultraviolet light undergoes a chemical reaction to become ink-attracting. The exposed coating then forms the image on the plate that will print. The rest of the coating, unexposed to the ultraviolet light, is washed off during subsequent processing.

When positive-working plates are exposed in the frame, the sensitized photopolymer coating radiated by the ultraviolet light is made unstable on exposure, and this portion is removed during processing. The unexposed areas are the ones that will print. A stabilization chemical is then applied to the unexposed emulsion in order to harden it. Some plates can be baked to “fix” and harden the image. Deletions can be made to the plate, by using a special eraser or brush-applied fluid. Deletions can be useful for printing run-ons of a poster, for example, with dates or venues deleted.

All plates are subject to wear. For example, after around 150,000 copies (or sometimes much lower numbers of copies) have been printed, both the image and the surface grain may begin to break up. Multi-metal plates with surfaces of hard-wearing chromium are specially designed for long print runs of between 800,000 and a million copies.

Positive-working plates produce less dot gain than plates made from negatives and are popular for web offset magazine printing. Bimetal plates are even better at controlling dot gain.

Conventionally, the main types of plates include the following types, electrostatic (sometimes referred to as electrophotographic), presensitized diazo, photopolymer, silver halide, bimetal, waterless, heat sensitive, hybrid, and ablation type plates.

Electrostatic (electrophotographic), plates are imaged like the drum in a photocopier except that in a photocopier the toner attracted to the drum is then transferred to another media, typically paper and fused to it, but in the case of electrostatic plates the plate is both the drum and media. The surface of the electrostatic plate is coated with a light sensitive coating typically Zinc Oxide. Upon the surface of the electrostatic plate is placed an electrical charge. Upon exposure to light reflected from the original artwork, like that in a photocopier, the charge is dissipated in areas struck by the reflected light. The charge remaining on the unexposed areas attracts a dry or liquid toner with an opposite charge. This toner is then fused to the plate with pressurized heat. Electrostatic plates can also be imaged directly with a laser similar to the ones used in conventional laser printers. In this case the laser directly strikes the electrostatic plate removing the electrical surface charge from the photoconductive coating of the electrostatic plate. The electrostatic plate must then be processed with chemicals that remove the coating in the non printed areas. Then the plate is treated with etch and gum to make it water receptive. During the chemical removal process, the dots can become slightly ragged, so these plates are not conventionally used for fine screens and process color printing. These electrostatic plates typically have base materials of paper, polyester or aluminum. These electrostatic plates can also be fed through a typical laser printer and toner may be imaged directly to them just as conventionally done with paper. The plate must then be processed with the same chemicals to remove the unwanted coating. This process is only available with the paper or polyester substrate.

Presensitized diazo plates are coated with organic compounds and have a shelf life of about a year. Wipe-on plates, coated at printers have a shelf life of one to two weeks. Most are made from negatives and, once exposed, are treated with an emulsion developer consisting of a lacquer and gum-etch in acid solution. As unexposed diazo is dissolved by the solution, the gum deposits on the non-printing areas for water-receptivity, and lacquer deposits on exposed images, making them ink-receptive. When developed, the plate is rinsed with water and coated with gum arabic solution. These are known as additive plates and can produce runs of, e.g., as long as 150,000. Some diazo plates are prelacquered and are capable of runs of, e.g., up to 250,000. These plates are developed using a special solvent, and are known as subtractive plates.

Photopolymer plates are coated with inert and abrasion-resistant organic compounds and are capable of press runs of, e.g., up to 250,000. These too are available as negative- and positive-working plates. Some photopolymer plates can be baked after processing to produce runs of over a million. Dye-sensitized photopolymers that may be exposed by lasers are used in digital computer-to-plate (CTP) systems.

Silver halide plates are coated with photosensitive compounds similar to slow photographic film. The emulsions are very light-sensitive to blue. Thus, the emulsions must be handled in yellow-filtered light. The coatings can be exposed optically using negatives, or digitally by lasers. The processing solutions contain heavy metal pollutants (silver) which must be treated with silver-recovery chemicals before being discharged.

Bimetal plates use presensitized polymer coatings consisting of a metal base with one or more metals plated on to it. Copper plated onto stainless steel or aluminum, or chromium plated onto copper, which may be plated onto a third metal base are conventionally used. These are almost indestructible, have good dot control and are capable of runs in the millions. Bimetal plates are also the most expensive.

Waterless plates consist of ink on aluminum for the image areas and a silicone rubber for the non-printing areas. Silicone rubber has very low surface tension and thus repels ink. However, because of the pressure and heat of printing, regular litho ink will smear over the silicone and cause scumming or toning. Waterless printing therefore must use special inks and temperature control. The technique also demands good grades of paper in order to avoid debris accumulating on the blanket.

Heat-sensitive plates are made from polymers that respond to heat rather than light. Heat-sensitive plates can thus be handled in daylight or artificial light. Heat sensitive plates are exposed using infrared laser diodes in special image-setters and processed in an aqueous solution. With baking, the heat sensitive plates are capable of runs of over a million.

Hybrid plates use two separate photosensitive coatings on metal plates: a silver halide coating that can be exposed either optically to film or digitally by lasers over a bottom coating of conventional photopolymer. When the top coating is processed, the bottom coating is exposed to UV light. The top coating is then removed and the photopolymer (bottom) coating is used for printing.

Ablation plates are made by a laser selectively burning tiny holes into thin coatings on a polyester or metal base. These can be produced digitally, require no chemical processing, and can be printed waterless. All the plates for a job can be imaged directly on the press, simultaneously and in register.

As will be apparent from the above, most plate coatings can be imaged digitally by laser. High-speed dye-sensitized photopolymers, silver halide, electrophotographic and ablation plates, coupled with digital systems have enabled computer to plate (CTP) systems. Thus, the platesetter may be replacing the imagesetter. Conventionally, a debate has continued as whether to use visible light-sensitive plates versus infrared imaging.

In the 1950s lithographic aluminum (AL) offset plates became widely used as masters for offset printers worldwide. The AL offset plates were manufactured by companies such as, e.g., Agfa of Agfa-Gevaert of Mortsel, Belgium; Fuji of Tokyo, Japan; Kodak-Polychrome of Rochester, N.Y., U.S.A.; and Mitsubishi of Mitsubishi Paper Mills Limited of Tokyo, Japan. FIG. 1 depicts a cross-section of a conventional AL lithographic offset plate 100, also referred to commonly as a “lithographic plate” or “litho plate.” The AL offset plate 100 includes an aluminum base 102, electromechanical graining 104, an anodizing coating 106, and a light sensitive emulsion 108. Graining may be accomplished mechanically by brushing or use of abrasives, or chemically, creating microscopic grains. The AL offset plates are imaged by exposing the light sensitive coating of the AL offset plates to an ultraviolet light source using a clear film positive or negative master image as a filter. The plates are available with the light sensitive coatings, called emulsions, which react to either positive or negative film depending on the customer preference.

The imaging process produces very high quality images but has several shortcomings, including, e.g., harmful chemicals, labor intensiveness of the process, and the process is slow.

Prior to 1970, lithographic plates were conventionally imaged by photographic copies of camera-ready masters. The conventional process of imaging began with taking a photograph of the master to be printed using, e.g., but not limited to, a static camera, and developing a negative (or positive) film. The film is laid firmly against the lithographic plate and exposed to an ultraviolet light source for typically two minutes, which hardens the light sensitive emulsion (or softens the emulsions for positives). The plate is washed with a cleaning agent, called the developer, in order to remove the unexposed portions of the emulsion (for positive film the exposed portion is removed). The plate is then mounted on an offset press for printing. The remaining emulsion, which represents the image to be printed, attracts ink and repels water. The grained aluminum base retains water and prevents ink from transferring.

In the 1970s photographic imagesetters conventionally began using low power lasers to produce film directly from digital computer files. The low power laser film production process bypassed the camera phase of film generation and improved quality substantially. The low power laser film production process uses the same harmful chemicals as the previous processes. Also, the low power laser film production process is typically very slow, as it can take several minutes to produce a single piece of film.

Also in the 1970s, polyester printing plates were first marketed. The polyester printing plate process involved using a conventional electrophotographic copier such as those available from Xerox Corporation of Rochester, N.Y., U.S.A. to image polyester plates with toner. Although adequate for very low quality work, the polyester plates were not suitable for the majority of the printing industry because of the low run length and poor image quality associated with conventionally available electrophotographic technology. Polyester was used as a base for this technology because electrophotographic copiers were designed to accept paper. Polyester, like paper, is an insulator so the copier can image toner to the polyester plate in the same way as for paper. Unfortunately, conventional electrophotographic copiers cannot image directly to metal.

In the early 1990s, polyester based plates were introduced for use in laser printers and these products are still in existence today. The process for using laser printers to print to polyester plates is similar to the electrophotographic copier process, but with the laser printer the quality was much improved as compared to the copier process. Although direct image polyester plates are available today, the typical offset printer prefers a metal master for several reasons. For example, metal is much more stable than polyester. Unlike polyester plates, metal also does not stretch on the offset press. Also, metal can be used with a much wider variety of press chemical and inks than can polyester. Metal plates can tolerate a far more abusive press than can a polyester plate. Metal plates produce higher quality images and longer run lengths. Unfortunately however, conventional metal plates cannot be used with conventional laser printers or copiers.

In the late 1990s, metal platesetters began to be marketed by such companies as Presstek of Hudson, N.Y., U.S.A.; Agfa of Agfa-Gevaert of Mortsel, Belgium; and AB Dick of Niles, Ill., U.S.A. The metal platesetters use high energy lasers to burn an image on an aluminum metal plate. Using the metal platesetters process (as illustrated in FIG. 2), an aluminum plate is coated with a material which when heated by the high energy laser, causes a microscopic explosion on the plate. FIG. 2 depicts a cross-sectional view of a high energy laser sensitive metal plate 200 including, e.g., but not limited to, an aluminum base 202, an ink receptive coating 204, an explosive layer coating 206, and a clear water receptive layer 208. Coated above the explosive layer 206 is a clear coat of a water receptive coating 208, such as, e.g., but not limited to, silicone. When this high energy highly focused laser heats the explosive layer 206 through the clear coating 208, the microscopic explosion blows the clear coating 208 from the surface of the plate 200, exposing the ink receptive layer 204 below. The master may then be mounted on a press for duplication. Drawbacks of the technology include a high cost of the imaging device used in the process, as well as a high cost of plate material, and slow speed associated with the process.

What is needed is an improved apparatus for printing, and an improved lithographic plate that provides the benefits of a metal plate, and the convenience and environmental friendliness of laser printer imaging.

### SUMMARY OF THE INVENTION

Various exemplary systems, apparatuses and conductive plates adapted to enable computer-to-metal platesetting are set forth according to the present invention. An exemplary embodiment of the present invention sets forth an apparatus including: an electrophotographic printing device adapted to provide an electrically isolated media path adapted to receive a conductive media.

In an exemplary embodiment the electrophotographic printing device can include media contacting components, where all of the media contacting components are electrically isolated.

In another exemplary embodiment, the conductive media, when in said electrically isolated media path, is not grounded, is not charged, and/or does not contact any voltage source. In one exemplary embodiment, the media contacting components can include insulators; non-conductive material; non-conductive connectors, screws, and washers; and/or insulating tape.

In another exemplary embodiment, the electrophotographic printing device may be adapted to run at a reduced print engine speed as compared to conventional print engine speed associated with a conventional electrophotographic printing device for use with non-conductive media. In one exemplary embodiment, the reduced print engine speed can be 3.33 ppm, 4 ppm, 5 ppm, less than 20 ppm, 28 inches per minute, 34 inches per minute, and/or 44 inches per minute.

In another exemplary embodiment, the electrophotographic printing device can be adapted to provide a higher fusing temperature as compared to a conventional fusing temperature associated with a conventional electrophotographic printing device for use with non-conductive media. In another exemplary embodiment, the higher fusing temperature can be about 400 degrees F.

In another exemplary embodiment, the electrically isolated media path can include a rounded path, no sharp corners, no sharp turns, no burrs, and/or no obstructions.

In another exemplary embodiment, the conductive media can include metal; aluminum; and/or lithograde aluminum.

In another exemplary embodiment of the present invention, a plate is set forth, including a conductive material adapted for use in an electrophotographic process.

In another exemplary embodiment, the conductive material can include aluminum. In one exemplary embodiment, the conductive material can include litho grade aluminum. In one exemplary embodiment, the litho grade aluminum can include a thickness of 5, 6, 8, 10, and/or 12 mils.

In another exemplary embodiment, the plate can include at least one non-square corner. In an exemplary embodiment, the non-square corner can include a rounded corner, a beveled corner, and/or a chamford corner. In yet another exemplary embodiment, the non-square corner can include a plurality of angles. In one exemplary embodiment, the plurality of angles can be 60 degrees or less.

In yet another exemplary embodiment of the present invention, the plate can include a protective edge. In an exemplary embodiment, the protective edge can include: tape; such as, e.g., but not limited to, masking tape; thin high temperature plastic sleeve or the like; dipped wax or other material; a non-burred edge and/or a dull edge.

In an exemplary embodiment of the present invention, the plate may consist of: an aluminum base, electromechanical graining, and an anodized coating.

In another exemplary embodiment of the present invention, the plate may consist essentially of: an aluminum base, electromechanical graining, and an anodized coating.

In yet another exemplary embodiment of the present invention, the plate may comprise an aluminum base, electromechanical graining, an anodized coating, and an absence of a light sensitive emulsion.

In yet another exemplary embodiment of the present invention, the plate may be cut, bagged, and shipped as a finished packaged product.

In yet another exemplary embodiment of the present invention, the plate may include non-square corners, a leading protective edge, and/or may be part of a packaged product.

In yet another exemplary embodiment of the present invention, the plate may include: an aluminum base; a water absorbing coating; and no light sensitive emulsion.

In yet another exemplary embodiment of the present invention, the plate may include conductive material including a metal plate. In one exemplary embodiment, the plate may further include: a water absorbing layer.

In yet another exemplary embodiment of the present invention, the plate consists: a metal plate; electromechanical graining, and an anodized coating.

In yet another exemplary embodiment of the present invention, the plate consists essentially of: a metal plate; electromechanical graining, and an anodized coating.

In yet another exemplary embodiment of the present invention, the plate includes a metal plate; electromechanical graining, an anodized coating; and no light sensitive emulsion.

In yet another exemplary embodiment of the present invention, the plate is finished into a packaged product immediately after graining and anodizing said conductive material.

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a diagram illustrating a cross-section of a conventional aluminum lithographic plate according to an exemplary embodiment of the present invention;

FIG. 2 depicts an exemplary embodiment of a diagram illustrating a cross-section of a high energy laser sensitive metal plate according to an exemplary embodiment of the present invention;

FIG. 3 depicts an exemplary embodiment of an exemplary block diagram of an electrophotographic printer according to an exemplary embodiment of the present invention;

FIG. 4 depicts an exemplary embodiment of a more detailed exemplary block diagram of an electrophotographic printer of an exemplary embodiment of the present invention;

FIG. 5 depicts an exemplary embodiment of a cross-section of an exemplary electrophotographic printer depicting an exemplary media path as might be used in an exemplary embodiment of the present invention;

FIG. 6 depicts an exemplary embodiment of a diagram comparing a conventional lithographic plate to an Aspen design conductive plate having exemplary rounded corners according to an exemplary embodiment of the present invention;

FIG. 7 depicts an exemplary embodiment of an exemplary masking tape protective barrier on the front edge of an exemplary conductive plate according to an exemplary embodiment of the present invention;

FIG. 8 depicts an exemplary embodiment of a conductive plate according to an exemplary embodiment of the present invention; and

FIG. 9 depicts an exemplary embodiment of a high intensity light source that may be used to adhere toner to the plate according to an exemplary embodiment of the present invention.

### DETAILED DESCRIPTION OF EXEMPLARY EMBODIMENTS OF THE PRESENT INVENTION

A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

The present invention sets forth a system that enables electrophotographic imaging of a metal plate. The present invention provides an aluminum-based, low cost, environmentally friendly, high speed, platesetting system.

An exemplary environment includes an IMPRESSIA™ PlateSetter platesetting system available from Xante' Corporation of Mobile, Ala., U.S.A. An exemplary embodiment of the present invention may be based around an electrophotographic print engine such as, e.g., but not limited to, a Fuji-Xerox Max electrophotographic print engine available from—Fuji-XEROX Corporation of Tokyo, Japan with a resolution of, e.g., but not limited to, up to 2400 dots per inch (dpi), or more.

Electrophotographic printing devices, typically referred to as laser printers, are designed to create an image by printing a series of dots on a print medium, typically paper. This image is created by a highly focused light source which is scanned at a specific rate across a charged surface of photosensitive material, typically referred to as the drum. This light source is modulated such that some areas are exposed and some are not, creating a predetermined pattern on the photosensitive material. The areas sensitized by the light source cause the material to bear a charge pattern corresponding to the desired image to be printed. The final printed material is created by the attraction of toner particles to the sensitized areas of photosensitive material and then transferring this toner to the print media.

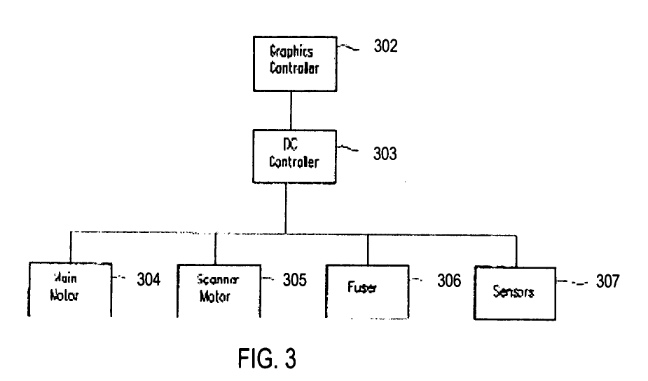

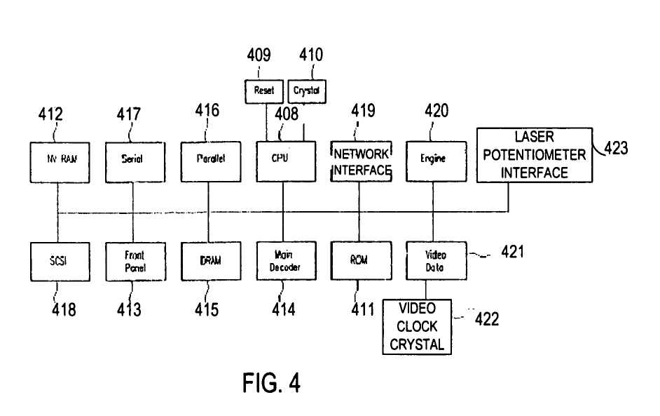

The majority of electrophotographic print engines are developed by a few large manufacturers, e.g. Canon of Tokyo, Japan, Fuji-Xerox of Tokyo, Japan; Lexmark of Lexington, Ky., USA; Minolta of Tokyo, Japan; and Toshiba of Tokyo, Japan. Referring to FIGS. 3 and 4, generally laser printers in addition to including electrographic print engines also include a graphics controller 302 which describes in an electronic form the page to be printed on the marking engine. Since an important customer desire is to produce the highest quality positive output, these devices may be each individually tuned at the manufacturing factory to produce the best possible positive paper output. Solid state lasers may be used by these vendors and each may produce a slightly different laser intensity.

As mentioned above, many original equipment manufacturer (OEM) print engines may be available. Printer controller developers integrate their controllers 302, 303 into these OEM print engines and strive to differentiate their printers to enhance their particular market share. Typically, features are controller dependent functions such as emulations, fonts, and processing performance. In electrophotographic printers, a RAM based image of the page to be printed may be created on the graphic controller 302 at the resolution of the marking engine. The graphic controller 302 may communicate with another controller 303 which may control mechanical aspects of the marking engine. This mechanical controller 303, typically called the direct current (DC) controller 303, among other tasks, has primary control of two key elements of the engine, the main motor 304 and laser scanner motor 305. The main motor may be responsible for all media movement of the marking engine. The laser scanner 305 may be responsible for spinning the rotating mirror used to reflect the laser beam and therefore scan the laser beam across the moving photosensitive drum.

When the graphic controller 302 communicates to the DC controller to start the printing process, the DC controller 303 may start the main motor 304 and laser scanner motor 305. Paper movement now may begin and may be controlled by the main motor 304. The digital image of the page may be transferred to the light sensitive drum. The rate at which this transfer takes place may be proportional to the rated speed of the marking engine. The drum rotates through a toner bin and toner may be attracted to the light sensitized area of the drum. Toner may be transferred conventionally to paper when toner is attracted away from the drum and to a highly charged roller located behind the media and intercepted by the media. The media may then heated by a fusing roller, i.e., the fuser 306, and toner may be melted into the paper.

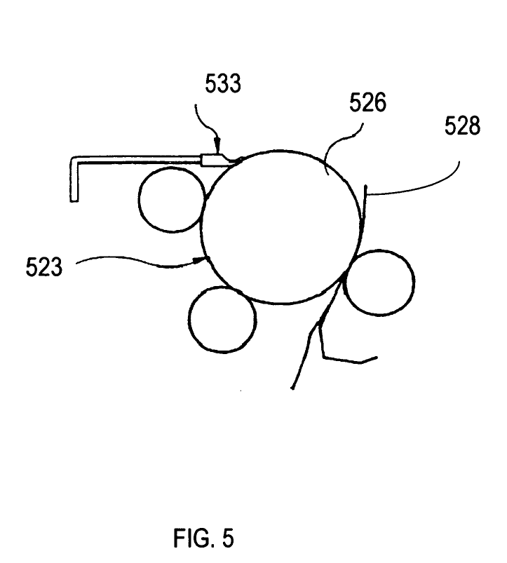

Referring to FIGS. 3, 4 and 5. The present invention is described as applied to an electrophotographic printer, such as a laser beam printer, although it should be understood that the present invention is compatible with other forms of electrophotographic printers such as LED printers. In a LED printer the laser scanner unit does not exist. Instead of one laser creating the image on the surface of the drum, a series of LED's are aligned across the surface of the drum, one LED for every dot per inch (DPI) of resolution. In this case all of the LED's power would be adjusted simultaneously in order to produce quality images. In electrophotographic printing, an image may be first created on a computer. The user of the computer may install appropriate driver software which may match the printing capability of the desired printer to the host software. During printing time the driver may convert the desired image to be printed into data, in a language (such as, e.g., PostScript™, etc.) understandable by the controller of the printing device. The data may be transferred to the intelligent graphics controller 302, typically residing in the printer. From the data the graphics controller 302 creates an exact image of the page to be printed in its memory, such as, e.g., but not limited to, digital random access memory (DRAM) 415.

The graphics controller 302 may have three main functions: receipt of the data from the host computer over a specified interface, interpretation of the data into an electronic image representing the page to be printed, and transfer of the image data to the marking engine. The graphics controller 302 may be controlled by a central processing unit (CPU) 408. The CPU 408 may receive a reset from a reset generator 409. The CPU 408 may receive a clock input from a CPU crystal oscillator 410. The CPU 408 itself may be, e.g., but not limited to, a 32 bit microprocessor that may execute instructions stored in memory, such as, e.g., but not limited to, a read only memory (ROM) 411. The ROM 411 may be used to store instructions of CPU 408, data for creating characters and data for interpreting information coming from the host computer. The graphics controller 302 may also contain another memory, such as, e.g., but not limited to, a non-volatile RAM (NVRAM) 412 which may be used to store, e.g., page count and setup information specified by the user without being erased by loss of power. A front panel interface 413 may be used to communicate with, e.g., but not limited to, an LCD module for displaying printer status and button keys that may be used to input setup information into the graphics controller 302. The main decoder and control 414 may determine the peripheral circuit to be accessed during a CPU 408 execution cycle and may supply the control signal for the specific timing characteristics required by each peripheral. The DRAM 415 may be used by the CPU 408 to store information about the current execution parameters of the CPU 408, may store incoming data from the host computer and may store a bit mapped image of the page being created and printed. A parallel interface 416 may control transfer of data from the host computer to the graphics controller 302 over the interface. A serial interface 417 may control transfer of data between the graphics controller 302 and a host computer when the host computer desires to send data serially. Of course, alternative interface buses may be used, as would be apparent to those skilled in the art, such as, e.g., but not limited to, universal serial bus (USB), etc. A small computer systems interface (SCSI) interface 418 may be used to control a storage device, such as, e.g., but not limited to, a hard disk for storage of fonts from the host computer and as an extension of the main DRAM 415 memory, although the hard disk may be slower and may be used when DRAM 415 memory space is exhausted. A network interface 419, such as, e.g., but not limited to, an Ethernet interface may be used to control data from the host computer when transfer is desired over an ethernet or alternative network. An engine control and status circuit 420 may be responsible for bidirectional communications with the DC controller 303. A video data control circuit 421 may be responsible for proper generation and timing of image data as the data may be transferred to the DC controller 303 during page printing. The rate at which image data is transferred may be specified by the clock rate of a video clock crystal 422.

The graphic controller 302 may communicate with another controller located inside the printer that the printer may be ready to begin printing. The second controller, typically called the DC controller 303, may be responsible for controlling the main motor 304, scanner motor 305, fuser 306, and sensors 307, that may report errors detected, such as, e.g., but not limited to, paper jams, paper sizes, optional trays, fusing temperature, etc.

The DC controller 303 may signal the main motor 304 and scanner motor 305 to begin to rotate. At this time the entire surface of the electrostatic drum 426 may be cleaned and recharged. The cleaning may be accomplished by the application of a rubber cleaning blade 533 which may scrape the surface of the drum 526, removing any leftover toner particles. The surface of the drum 526 may also be electrostatically cleaned by an erasing charge using, such as, e.g., but not limited to, an electromagnetic field of several hundred volts. After the proper speed and paper movement has been detected by the DC controller 303, the controller may notify the graphics controller 302 that the printer may be ready to begin imaging the page. The graphic controller 302 may begin transferring the data, typically referred to as video data, in a serial stream at a predetermined rate proportional to that of the speed of the laser printer, to the DC controller 303 in one line increments. At the same time the DC controller 303 may pass the video data to the laser 523, may pulse the laser 523 on and off corresponding to the DRAM 415 image of the page being printed.

The Laser 523 beam may be produced by a solid state laser which may be turned on and off by supplying or denying power. The light produced by the laser 523 may be highly focused by a collimator lens 524 (not shown) onto a rotating mirror 525 (also not shown) atop the scanner motor 305. The rotating mirror 525 may be a six-sided rotating polygon mirror whose purpose may be to sweep the highly focused laser 523 beam across the surface of the photosensitive cylindrical drum 526. Areas of the drum 526 not charged by the laser 523 may remain at a potential of, e.g., but not limited to, negative 600 volts. Areas charged by the laser 523 may be at, e.g., but not limited to, negative 100 volts.

During the printing process the DC controller 303 may also monitor sensors 307 inside the printer which may track movement of paper 528. The DC controller 303 may be preprogrammed with information about the speed of the engine and which sensors 307 should detect paper at which time in the printing process. If the appropriate sensors 307 do not report paper detection in the proper time frame proportional to that of the speed of the printer the DC controller 303 may stop movement of main motor 303 and scanner motor 305 and may report an error to the graphics controller 302.

Assuming no errors are detected in the printing process the laser 423 may image an exact replica of the desired printed output at the correct power level onto the surface of the electrophotographic drum 526.

The drum 526 may rotate at a rate controlled by the main motor 304 through what may be known as the developer 527 (not shown). The developer 527 material called toner may adhere to the areas of the drum 526 currently at, e.g., negative 100 volts potential, and not the, e.g., negative 600 volt areas. The toner may be black plastic resin ground to, e.g., but not limited to, between 6 and 12 microns in size and may be bound to iron particles. The iron particles may be attracted to a rotating cylindrical magnet located inside the developer unit 527. The toner particles may obtain a negative charge by contacting the cylinder which may be connected to a negative DC supply voltage. The negative charge of the toner particles may cause the toner particles to attract to the areas of the drum 526 exposed by the laser beam 523.

The paper, which may be traveling at the same speed as the electrophotographic drum 526, may contact the surface of the drum 526. A transfer charging roller 534 may produce a strong positive charge onto the back side of the paper as the paper moves across the drum 526. The stronger positive charge pulls the toner from the drum 526 and onto the paper. The paper moves to fuser 306 where a Teflon drum, which may be preheated to 360 F by an internal heating lamp controlled by the DC controller 303, and may rotate at the same speed as the paper and drum 526, may melt the toner and force the toner into the paper with the force of a soft back roller.

The DC controller 303 may be responsible for controlling the mechanical functions of the laser printer. The printer includes the CPU 428, which may be controlled by crystal timing, ROM 429, sensors 307, which detect engine functions, and control signals which drive the scanner motor 305, main motor 304, and laser beam 523.

In an exemplary embodiment of the invention, the printer engine 530 (not shown) may be a Fuji-Xerox 20 page-per-minute laser printer integrated with a graphics controller 302 and sold under the name IMPRESSIA by Xante' Corporation of Mobile, Ala.

Electrophotographic printers, also referred to as laser printers, have conventionally been designed to print on paper or other non-conductive material. Because paper is an electrical insulator, paper may carry a static charge that may conventionally inhibit transfer of toner to the paper medium and may reduce image quality. Polyester plate media, also an insulator, may similarly carry a static electric charge. Electrophotography is based on moving toner with electrical charges. Thus, any static charge must be removed from the paper in order to produce a quality image. To remove the static charge, the paper must be properly grounded. Similarly, for polyester plates, when performing computer to polyester plate imaging, again, the printing media must be grounded to remove static charge from the polyester plate print media. Thus, conventional electrophotographic printers and copiers include a metallic grounding brush, or the like, which contacts the print media to ground the print media.

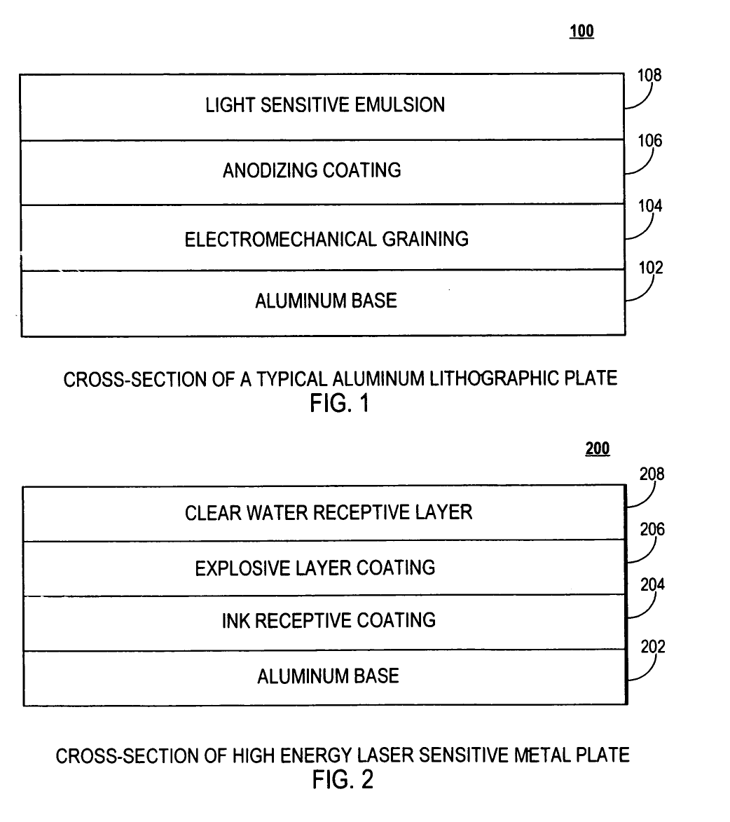

In an exemplary embodiment of the present invention, a conductive plate, by definition a non-insulator, is used. An exemplary conductive plate may include, e.g., a metal plate such as, e.g., but not limited to, an aluminum (AL) plate. Specifically, in an exemplary embodiment, the AL plate may be a “litho grade” AL plate such as, e.g., but not limited to, the litho grade AL plates such as, e.g., a modified version of those available from such manufacturers as, e.g., Agfa, Fuji, Kodak-Polychrome and Mitsubishi. Conventional lithograde AL plates are distributed as shown in FIG. 1. Lithograde AL may be manufactured using rolls of ultrapure (e.g., 99.9% pure) AL available from such manufacturers as, e.g., Mitsubishi Aluminum Co. of Tokyo, Japan, or Hydro Aluminium of Germany. Lithograde AL includes a grained and anodized version of the ultrapure AL, along with a light sensitive emulsion layer. The rolls of grained, anodized, and light sensitive emulsion coated lithograde AL are conventionally cut into rectangular plates and then are bagged and packaged for shipment as finished products. The conductive plate according to the present invention unlike a conventionally packaged lithograde plate, does not include a light sensitive emulsion layer. The present invention cuts, edge protects, bags and ships as finished product a grained and anodized AL plate having no light sensitive emulsion. Lithograde AL comes in various thicknesses including, e.g., but not limited to, 5, 6, 8, 10, 12 mil. In one exemplary embodiment of the present invention, a 6 mil (0.15 mm) AL plate may be used.

A conductive plate, such as, e.g., the lithograde AL plate according to the present invention, which is a conductor of electrical charge does not hold static electricity, unlike conventional insulator print media. A conductive plate, if grounded as is conventional, does not produce a quality transfer of toner from the imaging drum to the surface of the conductive plate. An exemplary embodiment of the present invention includes an electrophotographic printer adapted to include a completely electrically isolated media path for receiving the conductive plate and to which toner may be transferred throughout the imaging process. The electrographic printer according to the present invention electrically isolates the media path and therefore electrically isolated the conductive plate to allow transfer of toner. Specifically, in an exemplary embodiment, all metal components of a conventional media path may be replaced with non-conducting components. For example, metal screws and washers may be replaced with insulators such as, e.g., but not limited to, plastic screws and washers. Alternatively, components may be manufactured of other non-conducting materials. At no point while the conductive plate proceeds through the media path, may the conductive plate make contact with any conductor unless that conductor is also electrically isolated. It is important to note that while one portion of the conductive plate may be moving past a fuser causing toner to be fused to the conductive plate, another portion of the same conductive plate may be being imaged. Thus, the present invention provides an electrophotographic printer adapted to provide a completely electrically isolated media path for receiving the conductive plate.

Conventional electrophotographic processing used on paper or polyester does not achieve toner fusion on a conductive plate such as an aluminum plate. Since aluminum and other conductive plates are conductors of heat, while paper and polyester are insulators, it was determined that toner would not fuse with the same levels of heat and time of heating as used with insulative media. To fuse a toner image onto conductive plates, an increased amount of fusing time and a higher fusing temperature were desirable. According to an exemplary embodiment of the present invention, when an exemplary 0.15 mm (6 mil) aluminum plate is used, an increased amount of heat, and an increased amount of time of heating are used to fuse toner to the conductive media than conventionally used with insulative media. Specifically, in one exemplary embodiment, toner may be fused to the aluminum plate by reducing print engine speed to, e.g., but not limited to, 3.33 pages per minutes(ppm) (i.e., about 28 inches per minute(ipm)) 5 pages per minute(i.e., about 44 ipm), or 4 ppm (i.e., approximately 34 ipm) and by allowing fusing temperature to reach, e.g., but not limited to, approximately 400 degrees F. In comparison, at the temperature of 400 degrees F., a conventional laser printer could image an insulative media at a rate of 40 ppm. In an alternative exemplary embodiment, a post fusing process may be used in combination with the present invention. The post fusing process may include further baking the toner on the plate in an external baker, comparable to a conventional oven at, e.g., 400 degrees F.

FIG. 9 depicts an exemplary embodiment of a device that may be used to adhere toner to the plate, according to an exemplary embodiment. According to an exemplary embodiment of the present invention, a high intensity light source (such as, e.g., a halogen bulb) may be encircled, or partially enclosed in a mirrored chamber along with the plate and attracted toner may be used to adhere the toner to the metal plate. In an exemplary embodiment, the chamber may include two reflective plates that can concentrate or direct the light from the light source to radiate heat toward the toner. In one exemplary embodiment, the plate may be fused using the absorbed light of a radiant heat source. In an exemplary embodiment, radiant fusing may be used to cause the toner to adhere to the metal. The light source radiates heat so as to fuse the toner. In an exemplary embodiment, mirrors may be used to focus or direct the light in a particular direction.

According to another exemplary embodiment of the present invention, a conductive plate having various features, may be provided. Conventionally, lithographic plates are always produced with some sort of light sensitive emulsion above a grained and anodized aluminum base. An aluminum plate according to an exemplary embodiment of the present invention, includes no light sensitive emulsion (LSE) layer above the grained and anodized aluminum. According to the present invention, toner imaged and fused by the electrophotographic laser print engine in accordance with the present invention, replaces the ink receptive layer on the conductive plate. The conductive plate, according to the present invention, may include merely grained and anodized aluminum. Anodizing adds strength to litho grade AL. Graining is added to provide a water absorbing coating. Graining was previously achieved by scraping the surface of the aluminum plate. Today graining is achieved by a chemical process that causes grooves to be made in the surface of the aluminum. According to another exemplary embodiment, aluminum plus a water absorbing coating may be used.

According to another exemplary embodiment, another conductive material other than aluminum may be imaged using the described electrophotography to metal (ETM) or computer to metal (CTM) process according to the present invention. Conventionally, signs may be manufactured by adhering ink from an ink jet printer to metal. Using the present invention, toner may be adhered to metal or another conductor using electrophotography. For example, a sign may be produced by imaging toner onto metal, using the present invention.

Another exemplary embodiment of the present invention provides a plate that avoids damaging the sensitive electrophotographic drum used in the electrophotographic laser printing process. All conventional, known metal offset plates have sharp 90 degree corners and are rectangular in shape as depicted in FIG. 6. FIG. 6 depicts a diagram 600 illustrating a conventional conductive plate 602 having 90 degree (right angle) corner 606. FIG. 6 also depicts an exemplary embodiment of the present invention including an improved conductive plate design 604 referred to as the Aspen plate design, having rounded corners 608. The conventional corners 606 are easily bent. A bent corner 606 defect can easily scar the surface of the electrophotographic print drum or fuser, causing great expense. To overcome this shortcoming of conventional conductive plates, it was determined that at least the leading corners, and potentially all corners 608 may be rounded, or shaped at multiple angles of less than 60 degrees such as depicted in FIG. 6. The rounded corners 608 of the Aspen plate 604 give the corners far greater strength as compared to conventional right angle corners 606 and reduce the instance of drum or fuser damage.

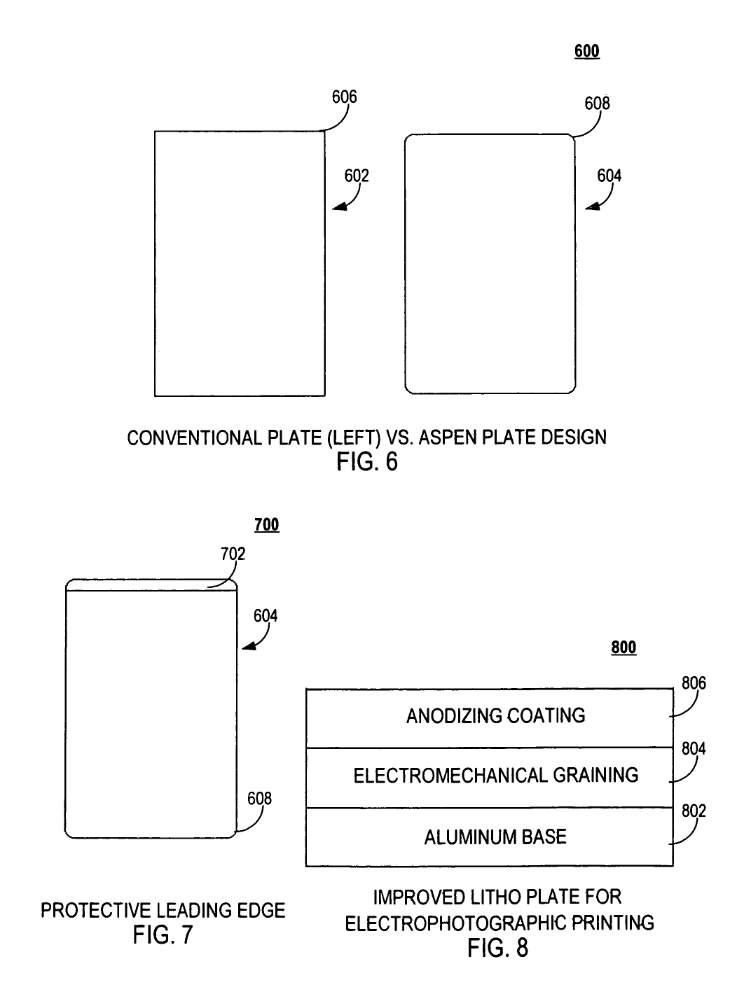

FIG. 7 depicts diagram 700 of an illustrative protective sleeve 702 of another exemplary embodiment of the Aspen plate design according to an exemplary embodiment of the present invention. Aspen plate 604 is depicted including rounded corners 608 and including a protective covering 702 over at least the leading edge of the plate. The protective sleeve 702 dulls the front edge of the plate to ensure smooth feeding through the media path of the printer. By protecting the front edge of the plate 604 during feeding through the media path, the otherwise sharp edge of plate 604 is prevented from jamming from, e.g., hitting a burr that would otherwise prevent feeding of the plate. The protective sleeve 702 also further prevents scarring of the drum or fuser. By blunting the sharp leading edge of the plate 604 the plate is prevented from scratching, or becoming hooked on an irregularity of a media path during feeding. Several exemplary embodiments of protective sleeves may include, e.g., but are not limited to, a thin high temperature plastic sleeve, tape, electrical tape, masking tape, a dipped wax, plastic or other material for coating the leading edge. In an exemplary embodiment, the sleeve 702 may be ¼ inch wide and may span the width of the plate as shown in the exemplary diagram 700. Other protective coverings may be used as will be apparent to those skilled in the relevant art.

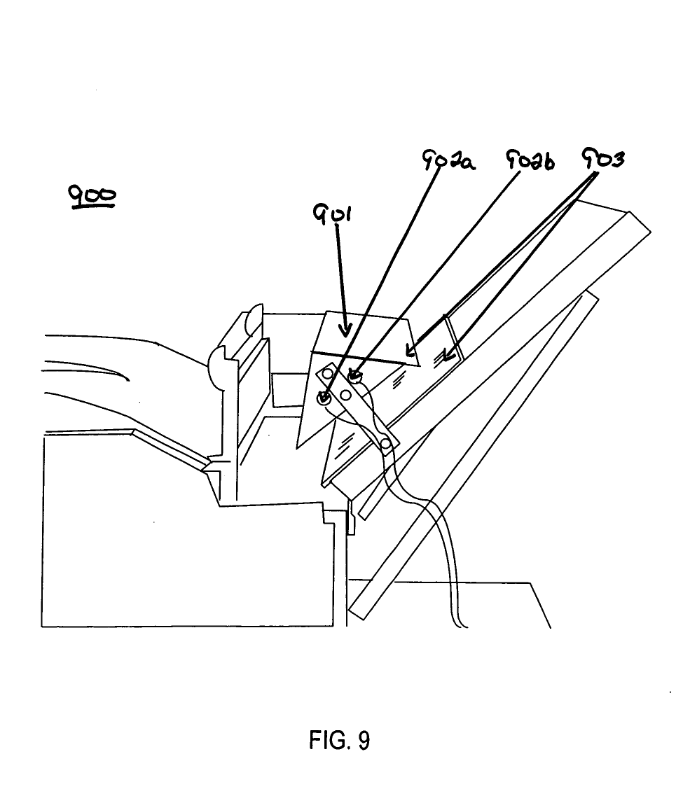

FIG. 8 depicts an exemplary embodiment of a conductive plate 800 according to an exemplary embodiment of the present invention. The conductive plate 800 includes a conductive base and a water absorbing layer. In one exemplary embodiment, the conductive plate 800 may include an AL base 802, a grained layer 804, and an anodized layer 806. Anodizing of the AL base lay 802 may be performed using any of various well known processes. Graining of AL base layer 802 may be accomplished electrochemically using any of various known processes.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. An apparatus comprising:
an electrophotographic printing device adapted to provide an electrically isolated media path adapted to receive a conductive media.

2. The apparatus according to claim 1, wherein said electrophotographic printing device comprises media contacting components, wherein all of said media contacting components are electrically isolated.

3. The apparatus according to claim 1, wherein said conductive media, when in said electrically isolated media path, comprises at least one of: is not grounded; is not charged; and does not contact any voltage source.

4. The apparatus according to claim 1, wherein said electrophotographic printing device is adapted to run at a reduced print engine speed as compared to conventional print engine speed associated with a conventional electrophotographic printing device for use with non-conductive media.

5. The apparatus according to claim 4, wherein said reduced print engine speed comprises about at least one of 3.33 ppm, 4 ppm, 5 ppm, less than 20 ppm, 28 inches per minute, 34 inches per minute, and 44 inches per minute.

6. The apparatus according to claim 1, wherein said electrophotographic printing device is adapted to provide a higher fusing temperature as compared to a conventional fusing temperature associated with a conventional electrophotographic printing device for use with non-conductive media.

7. The apparatus according to claim 6, wherein said higher fusing temperature is about 400 degrees F.

8. The apparatus according to claim 1, wherein said electrophotographic printing device is adapted to provide a lower fusing temperature as compared the temperature necessary to fully adhere the toner to the media and the media is then placed inside a baking unit to complete the fusing process of the toner to the media.

9. The apparatus according to claim 1, wherein said electrophotographic printing device is adapted to radiant fusing with a high intensity light source to adhere the toner to the media.

10. The apparatus according to claim 1, wherein said electrically isolated media path comprises at least one of a rounded path, no sharp corners, no sharp turns, no burrs, and no obstructions.

11. The apparatus according to claim 1, wherein the conductive media comprises at least one of: metal; aluminum; and lithograde aluminum.

12-33. (canceled)

34. A electrophotographic printing method comprising:
providing an electrically isolated media path adapted to receive a conductive media in an electrophotographic printing device.

35. The electrophotographic printing method of claim 34, further comprising:
adjusting a speed of said electrophotographic printing device for use with a non-conductive media.

36. The electrophotographic printing method of claim 34, further comprising:
adjusting a fusing temperature of said electrophotographic printing device for use with a non-conductive media.

37. The electrophotographic printing method of claim 34, further comprising:
providing a fusing temperature of said electrophotographic printing device to adhere a toner to said media.

38. The electrophotographic printing method of claim 34, further comprising:
placing said media inside a baking unit to complete a fusing of said toner to said media.

39. The electrophotographic printing method of claim 34, further comprising:
providing radiant fusing said media with a high intensity light source to adhere said toner to said media.
